(19) United States
(12) Patent Application Publication
(10) Pub. No.: US 2025/0013339 A1
(43) Pub. Date: Jan. 9, 2025

(54) DISPLAY CONTROL METHOD AND APPARATUS, AND ELECTRONIC DEVICE AND STORAGE MEDIUM

(71) Applicant: Beijing Zitiao Network Technology Co., Ltd., Beijing (CN)

(72) Inventors: Jie YU, Beijing (CN); Zhong WANG, Beijing (CN); Chen ZHAO, Beijing (CN); Chao ZHANG, Beijing (CN)

(21) Appl. No.: 18/705,456

(22) PCT Filed: Nov. 9, 2022
(86) PCT No.: PCT/CN2022/130811

§ 371 Date: Apr. 26, 2024

(30) Foreign Application Priority Data
Nov. 11, 2021 (CN) 202111333504.1

(51) Int. Cl. G06F 3/0481

(52) U.S. Cl. CPC G06F 3/0481

(57) ABSTRACT

The present disclosure provides a display control method and apparatus, an electronic device, and a storage medium. The present disclosure provides a display control method, including: determining a target control associated with a target trigger rule in response to at least one trigger rule being hit, where the target trigger rule is the hit trigger rule; and displaying the target control in an input box of a chat interface or an associated area of the input box, where the target control is configured to perform a corresponding function after being triggered.

### CROSS-REFERENCE TO RELATED APPLICATIONS

This application is filed based on and claims priority to Chinese Patent Application No. 202111333504.1, filed on Nov. 11, 2021, and entitled “DISPLAY CONTROL METHOD AND APPARATUS, ELECTRONIC DEVICE, AND STORAGE MEDIUM”, which is incorporated herein by reference in its entirety.

### TECHNICAL FIELD

The present disclosure relates to the field of computer technologies, and in particular, to a display control method and apparatus, an electronic device, and a storage medium.

### BACKGROUND OF THE INVENTION

Users chat in a chat interface and send messages, files, links, etc. to other users through the chat interface.

### SUMMARY OF THE INVENTION

The present disclosure provides a display control method and apparatus, an electronic device, and a storage medium.

The present disclosure employs the following technical solutions.

In some embodiments, the present disclosure provides a display control method, including:
determining a target control associated with a target trigger rule in response to at least one trigger rule being hit, where the target trigger rule is the hit trigger rule; and
displaying the target control in an input box of a chat interface or an associated area of the input box,
where the target control is configured to perform a corresponding function after being triggered.

In some embodiments, the present disclosure provides a display control apparatus, including:
a control unit configured to determine a target control associated with a target trigger rule in response to at least one trigger rule being hit, wherein the target trigger rule is the hit trigger rule; and
a display unit configured to display the target control in an input box of a chat interface or an associated area of the input box,
where the target control is configured to perform a corresponding function after being triggered.

In some embodiments, the present disclosure provides an electronic device, including: at least one memory and at least one processor,
where the memory is configured to store program code, and the processor is configured to call the program code stored in the memory to perform the method described above.

In some embodiments, the present disclosure provides a computer-readable storage medium configured to store program code that, when executed by a processor, causes the processor to perform the method described above.

The present disclosure provides a display control method, including: determining a target control associated with a target trigger rule in response to at least one trigger rule being hit, where the target trigger rule is the hit trigger rule; and displaying the target control in an input box of a chat interface or an associated area of the input box, where the target control is configured to perform a corresponding function after being triggered. In the present disclosure, the displayed control can dynamically change to adapt to real-time requirements of users.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a flowchart of a display control method according to an embodiment of the present disclosure;

FIG. 2 is a schematic diagram of display of a chat interface according to an embodiment of the present disclosure:

FIG. 3 is a schematic diagram of display of a chat interface according to an embodiment of the present disclosure:

FIG. 4 is a schematic diagram of display of a chat interface according to an embodiment of the present disclosure; and

FIG. 5 is a schematic diagram of a structure of an electronic device according to an embodiment of the present disclosure.

### DETAILED DESCRIPTION OF THE INVENTION

Embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in order, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifier “a/an” mentioned in the present disclosure is illustrative and not restrictive, and those skilled in the art should understand that unless the context clearly indicates otherwise, the modifier should be understood as “one or more”.

The names of messages or information exchanged between a plurality of apparatuses in the implementations of the present disclosure are used for illustrative purposes only, and are not used to limit the scope of these messages or information.

The solutions provided in embodiments of the present disclosure will be described in detail below in conjunction with the accompanying drawings.

A user chats with another user in a chat interface. In some cases, messaging software provides a quick reply function to facilitate the user to reply quickly. However, this can provide only the quick replies feature, and cannot provide other features such as page jump and application opening. Moreover, quick replies that the user can trigger are fixed, with poor flexibility and poor user experience.

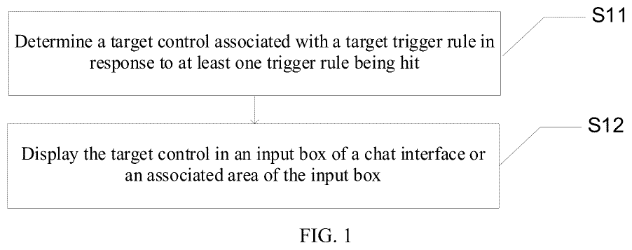

As shown in FIG. 1, FIG. 1 is a flowchart of a display control method according to an embodiment of the present disclosure. The method includes the following steps.

S11: Determine a target control associated with a target trigger rule in response to at least one trigger rule being hit.

In some embodiments, the display control method provided in the present disclosure is applied to messaging software, for example but not limited to, instant messaging software. The trigger rule is a trigger rule for a control, that is, the trigger rule is associated with the control. The target trigger rule is the hit trigger rule, and the trigger rule being hit means that the trigger rule is met. In some embodiments, a time when the control associated with the trigger rule can be displayed is set in the trigger rule.

S12: Display the target control in an input box of a chat interface or an associated area of the input box.

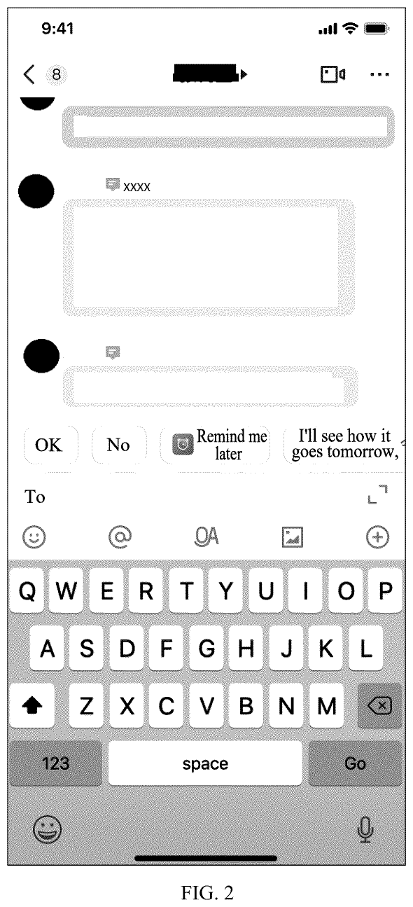

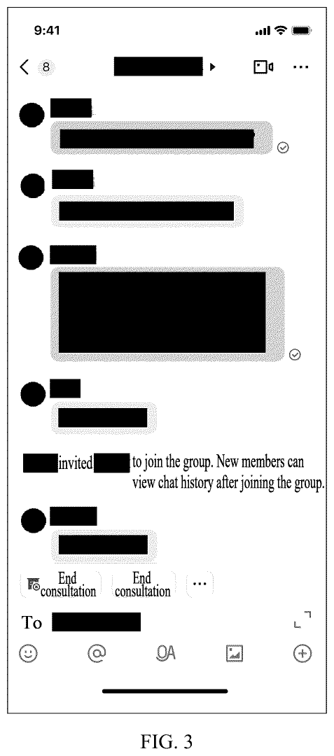

In some embodiments, referring to FIGS. 2 and 3, the chat interface may be a one-on-one or group chat interface with other users, the input box is an area for entering information, and the associated area of the input box may be an area above the input box. The target control is configured to perform a corresponding function after being triggered. The target control may be displayed in the input box, or the target control may be displayed in the associated area of the input box.

In some embodiments of the present disclosure, the control displayed in the input box or the associated area of the input box is not completely fixed. The trigger rule is preset for the control that can be displayed in the input box or the associated area of the input box. If the trigger rule is met, the target control is displayed in the input box or the associated area. In this way, the control displayed in the input box or the associated area can change with a trigger condition that is met, thereby meeting requirements of users in real time. In this embodiment of the present disclosure, setting of the trigger rule allows the control displayed in the input box or the associated area to change automatically and dynamically instead of being completely fixed, so that in each different scenario, the user can automatically experience an entry to an immediately needed feature in the current scenario. Therefore, the displayed control meets requirements of users, and user experience is improved.

In some embodiments of the present disclosure, in response to at least one trigger rule being hit includes: in response to the at least one trigger rule being hit by received information: or in response to the at least one trigger rule being hit by a detected operation: or in response to the at least one trigger rule being hit by historical information from an associated user of the chat interface.

In some embodiments, the trigger rule may specify the received information, the user operation, and the historical information from the associated user. The received information may be information sent by a user who chats with a current user in the chat interface. The detected operation may be an operation of the current user. The associated user of the chat interface may be the current user. The historical information may include historical messages sent or received by the current user in the past and historical operations performed by the current user in the past. The historical operations may be, for example, opened applications, visited pages, used documents, etc. A target control that needs to be displayed is suggested based on the historical operations of the user, so that the displayed target control can match the user operation.

In some embodiments of the present disclosure, the target control includes at least one of the following: a time zone information control, an information reply control, a page jump control, an information forwarding control, a target type information display control, or an application control. Certainly, the target control in the present disclosure may further include other controls and is not limited to these types of controls.

In some embodiments, the time zone information control is configured to display time zone information, for example, a time zone of a location of the user who is chatting with the current user. For example, the current user is chatting with a first user, and a trigger condition of the time zone information control is that the two parties in the chat are located in different countries and have different time zones, that is, if the first user is located abroad, the trigger condition is met, so that the time zone information control may be displayed, and a time zone of a location of the first user is displayed in the time zone information control. In some embodiments, after the time zone information control is triggered, both time of the current user and other users in the chat may be displayed in sent information. The page jump control is pre-bound with a link, which points to a target page. The target page may be an internal page or an external page. The target page may be opened through triggering of the page jump control. In some embodiments, a trigger condition of the page jump control may be that a user has recently visited the target page or the target page is involved in chat contents. The information forwarding control may be configured to send information to a target object. The target object may be a contact or a group. After the information forwarding control is triggered, a message in the chat interface may be sent to the target object. The target type information display control is configured to display or send target type information after being triggered. The target type information may be a local document, an online document, a folder, etc. For example, a trigger condition may be set as presence of a certain number of documents in a user chat history. The target type information display control is associated with the documents, and after the target type information display control is triggered, all the documents are displayed. The application control is configured to open a specific application after being triggered. The application may be an external application or an internal applet. For example, a trigger condition may be that the specific application is mentioned in the chat history. In this case, the application control for the specific application is displayed, and after the application control is triggered, the specific application is opened.

In some embodiments of the present disclosure, the trigger rule includes: at least one of a priority of an associated control, an appearance rule of the associated control, and a hiding rule of the associated control. In some embodiments, the priority is used to determine a display priority level of the target control. Since in some cases, trigger conditions for more than one target control may be met, a plurality of target controls need to be displayed. Moreover, since there may be too many target controls to be fully displayed, it is necessary to determine which target controls need to be displayed and which order these target controls need to be displayed in. In some embodiments, the method further includes: determining, based on a priority of the target control, a display position of the target control in the input box or the associated area. For example, the target controls are displayed from left to right in descending order of priorities. The appearance rule is used to determine when to display a control, and if the appearance rule of the target control is hit, the target control is displayed. The hiding rule is used to determine when to hide a corresponding control. The hiding rule is set because as more trigger rules are hit by the user, the target controls that need to be displayed inevitably gradually increase, but it is impossible to display all the target controls. The hiding rule is, for example, that a target control is hidden after being displayed for a period of time, or that a target control is hidden after it has not been used for a period of time. This can prevent user inconvenience caused by too many target controls.

In some embodiments of the present disclosure, if no trigger rule is hit, a suggested control is displayed in the input box of the chat interface or the associated area of the input box, where the suggested control is determined based on a behavior of a current user. In some embodiments, if no trigger rule is hit, the suggested control may be displayed for a user, where the suggested control is determined based on the behavior of the user. For example, if the user often browses a specific web page, the suggested control may be a control that opens the web page, or if the user often consults a document, the suggested control may be a control that opens the document.

In some embodiments, if at least two target controls are mutually exclusive, a control that needs to be displayed is determined from the mutually exclusive target controls based on the control currently displayed in the input box or the associated area of the input box. In some embodiments, the target controls may have the mutually exclusive relationship, that is, one target control cannot be displayed together with another target control. In this case, if trigger rules of mutually exclusive target controls are hit, which controls are to be displayed can be determined based on a currently displayed control. For example, based on a type and an effect of the currently display control, controls that are similar in type or effect to the currently displayed control may be displayed. For example, a reading control and an entertainment control may be set to be mutually exclusive. If trigger rules of these two controls are currently hit, and a note control is currently displayed, it is determined that the reading control rather than the entertainment control needs to be displayed. In some embodiments of the present disclosure, the trigger rule and the control associated with the trigger rule are customizable. In some embodiments, a user with target permissions can customize the trigger rule, as well as the control and a function of the control, or can grant another user permissions to customize the trigger rule and the control.

In some embodiments of the present disclosure, at least one common control is set in the input box of the chat interface or the associated area of the input box, and a registration interface is provided for the common control, where the registration interface is configured to set for the common control at least one of the following: a life cycle, displayed content, a trigger rule, content for determining whether the trigger rule is hit, and a function performed after the trigger rule is hit; and the target control belongs to the common control.

In some embodiments, common controls are provided in the input box or the associated area, and the target control is also one or more of the common controls. In some embodiments, the target control is specifically a common control for which a trigger rule and an execution function have been set. In some embodiments, the common control is an open common control and has the registration interface, through which the common control can be customized to set its life cycle, displayed content, trigger rule, and function, where the life cycle refers to a period of time for which the common control can be displayed. For example, the common control may be displayed while a chat is open, or at certain predetermined times. The displayed content refers to a text, or a symbol, or a combination thereof, displayed in the common control. The contents for determining whether the trigger rule is hit refer to contents that the common control is of interest. For example, if the trigger rule is that a chat history includes certain words, the contents of interest are the chat history, or if the trigger rule is that a user performs certain actions, the contents of interest is actions of the user. In some embodiments of the present disclosure, provision of the common control in the input box or the associated area, and the registration interface allows customization of the common control as needed. When the common controls are provided in advance and a unified interface is provided, there is no need to consider compatibility between individual controls, thereby avoiding incompatibility issues caused by differences in display or architecture due to the customization of controls by users.

In some embodiments of the present disclosure, the common control is displayed in a display container of the input box of the chat interface or a display container of the associated area of the input box, and the display container manages a priority of the displayed common control. In some embodiments, the common control is displayed in the display container. The display container may be, for example, an object of a view class or its subclass. The common control in the display container has a corresponding priority, and the priority is used to determine a common control to be displayed preferentially. In some embodiments, the priorities of the common controls are managed uniformly through the display container. In this way, there is no need to design priorities when customizing the common controls, but instead, the priorities are controlled uniformly in the display container, thereby reducing the coupling between code and improving the code reusability.

In some embodiments of the present disclosure, user types include a first type of user and a second type of user belonging to the first type of user; and a user with a first permission in the first type of user is able to set whether the second type of user is permitted to customize the trigger rule and the control associated with the trigger rule.

In some embodiments, the first type of user may be a group user, the second type of user may be an individual user in the group user, and the first permission may be, for example, management permission. In this way, the first type of user may control, by setting whether the second type of user can customize the trigger rules and the controls, whether the target controls displayed to the second type of users are the same or different, thereby achieving rational management of permissions.

In some embodiments, in response to customization of at least one control as a fixed control: fixedly displaying the fixed control in the input box of the chat interface or the associated area of the input box. In some embodiments, the input box or associated area may have the fixed control that is fixedly displayed. The fixed control is always displayed in the input box or the associated area. A user may define the common control as the fixed control. In this way, several controls which are most frequently used by the user can be fixedly displayed, which makes it easy for the user to quickly jump or open a file. Displayed content and a function of the fixed control can also be customized.

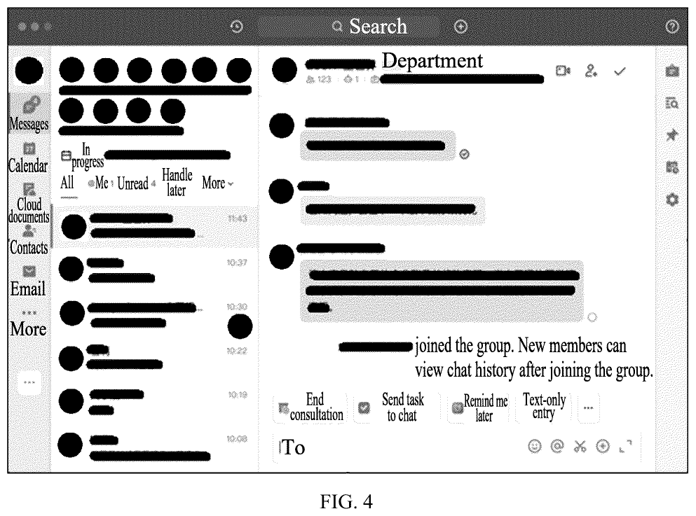

In some embodiments, n controls are displayable in the input box or the associated area, and if a number of the target controls exceeds n. (n-1) target controls and an extended control are displayed in the input box or the associated area, where the extended control is configured to: after being triggered, display a target control that is not displayed in the input box or the associated area. In some embodiments, it may be set that a maximum of seven controls are displayed. If more than seven controls need to be displayed, only six of them are displayed, and an extended control is displayed at a position of the seventh control. The extended control may be, for example, “More” or “ . . . ”, when triggered. In some embodiments, n is not less than 2. In an example in which n is 5, referring to FIG. 4, when the number of the target controls that need to be displayed exceeds 5, the extended control “ . . . ” is displayed at a position of the fifth control. After the extended control is triggered, a remaining undisplayed target control is displayed.

In some embodiments of the present disclosure, referring to FIG. 4, the target control has displayed content, and the displayed content includes at least one of a text and an icon.

In some embodiments of the present disclosure, the trigger rule can be written in the control. If a user hits some trigger rules, a corresponding target control may be automatically and dynamically displayed in the associated area above the input box. Logical priorities, and appearance and exit rules of different controls are uniformly specified. In some embodiments, when no trigger rule is hit by a user, an intelligently suggested control may be given to the user. An administrator can configure whether the control displayed in the input box or the associated area can be customized. If user customization is allowed, users can also define their own controls to jump to a user-defined path.

An embodiment of the present disclosure further provides a display control apparatus, including:
a control unit configured to determine a target control associated with a target trigger rule in response to at least one trigger rule being hit, where the target trigger rule is the hit trigger rule; and
a display unit configured to display the target control in an input box of a chat interface or an associated area of the input box, where the target control is configured to perform a corresponding function after being triggered.

In some embodiments, in response to at least one trigger rule being hit includes: in response to the at least one trigger rule being hit by received information: or in response to the at least one trigger rule being hit by a detected operation: or in response to the at least one trigger rule being hit by historical information from an associated user of the chat interface.

In some embodiments, the target control includes at least one of the following: a time zone information control, an information reply control, a page jump control, an information forwarding control, a target type information display control, or an application control.

In some embodiments, the trigger rule includes: at least one of a priority of an associated control, an appearance rule of the associated control, and a hiding rule of the associated control.

In some embodiments, the control unit is further configured to determine, based on a priority of the target control, a display position of the target control in the input box or the associated area.

In some embodiments, the display unit is further configured to: if no trigger rule is hit, display a suggested control in the input box of the chat interface or the associated area of the input box, where the suggested control is determined based on a behavior of a current user.

In some embodiments, the control unit is further configured to: if at least two target controls are mutually exclusive, determine, from the mutually exclusive target controls based on the control currently displayed in the input box or the associated area of the input box, a control that needs to be displayed.

In some embodiments, the trigger rule and the control associated with the trigger rule are customizable.

In some embodiments, at least one common control is set in the input box of the chat interface or the associated area of the input box, and a registration interface is provided for the common control, where the registration interface is configured to set for the common control at least one of the following: a life cycle, displayed content, a trigger rule, content for determining whether the trigger rule is hit, and a function performed after the trigger rule is hit; and the target control belongs to the common control.

In some embodiments, the common control is displayed in a display container of the input box of the chat interface or a display container of the associated area of the input box, and the display container manages a priority of the displayed common control.

In some embodiments, user types include a first type of user and a second type of user belonging to the first type of user; and a user with a first permission in the first type of user is able to set whether the second type of user is permitted to customize the trigger rule and the control associated with the trigger rule.

In some embodiments, the display unit is further configured to: in response to customization of at least one control as a fixed control, fixedly display the fixed control in the input box of the chat interface or the associated area of the input box.

In some embodiments, n controls are displayable in the input box or the associated area, and if a number of the target controls exceeds n. (n-1) target controls and an extended control are displayed in the input box or the associated area, where the extended control is configured to: after being triggered, display a target control that is not displayed in the input box or the associated area.

In some embodiments, the target control has displayed content, and the displayed content includes at least one of a text and an icon.

The apparatus embodiment is substantially corresponding to the method embodiment, and therefore for a related part, reference may be made to the part of the description of the method embodiment. The apparatus embodiment described above is only illustrative, and the modules described as separate modules therein may or may not be separate. Some or all of the modules may be selected according to actual needs to achieve the objectives of the solutions of the embodiments, which can be understood and implemented by a person of ordinary skill in the art without involving any inventive effort.

The method and apparatus according to the present disclosure are described above based on the embodiments and application examples. In addition, the present disclosure further provides an electronic device and a computer-readable storage medium. The electronic device and computer-readable storage medium are described below.

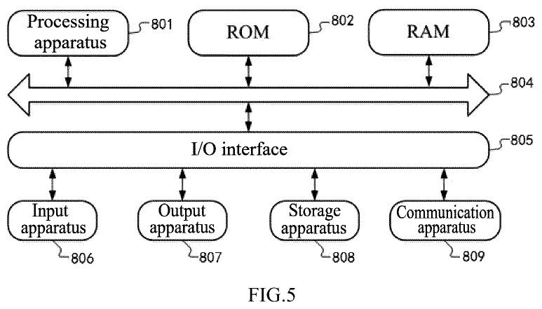

FIG. 5 is a schematic diagram of a structure of an electronic device (e.g., a terminal device or a server) 800 suitable for implementing the embodiments of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in the figure is merely an example, and shall not impose any limitation on the function and scope of use of the embodiments of the present disclosure.

The electronic device 800 may include a processing apparatus (e.g., a central processor, a graphics processor, etc.) 801 that may perform a variety of appropriate actions and processing in accordance with a program stored in a read-only memory (ROM) 802 or a program loaded from a storage apparatus 808 into a random-access memory (RAM) 803. The RAM 803 further stores various programs and data required for the operation of the electronic device 800. The processing apparatus 801, the ROM 802, and the RAM 803 are connected to each other through a bus 804. An input/output (I/O) interface 805 is also connected to the bus 804.

Generally, the following apparatuses may be connected to the I/O interface 805: an input apparatus 806 including, for example, a touch screen, a touchpad, a keyboard, a mouse, a camera, a microphone, an accelerometer, a gyroscope, etc.: an output apparatus 807, for example, including a liquid crystal display (LCD), a speaker, a vibrator, etc.: a storage apparatus 808, for example, including a tape, a hard disk, etc.; and a communication apparatus 809. The communication apparatus 809 may allow the electronic device 800 to perform wireless or wired communication with other devices to exchange data. Although the figure shows the electronic device 800 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded and installed from a network through the communication apparatus 809, or installed from the storage apparatus 808, or installed from the ROM 802. When the computer program is executed by the processing apparatus 801, the above-mentioned functions defined in the method of the embodiment of the present disclosure are performed.

It should be noted that the above computer-readable medium described in the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server can communicate using any currently known or future-developed network protocol such as a Hypertext Transfer Protocol (HTTP), and can be connected to digital data communication (for example, communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs, and the one or more programs, when executed by the electronic device, cause the electronic device to perform the above method according to the present disclosure.

The computer program codes for performing the operations of the present disclosure may be written in one or more programming languages or a combination thereof, where the programming languages include an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving a remote computer, the remote computer may be connected to a computer of a user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. The name of a unit does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC) system, a complex programmable logic device (CPLD), and the like.

In the context of the present disclosure, a machine-readable medium may be a tangible medium that may contain or store a program used by or in combination with an instruction execution system, apparatus, or device. A machine-readable medium may be a machine-readable signal medium or a machine-readable storage medium. A machine-readable medium may include, but is not limited to, electronic, magnetic, optical, electromagnetic, infrared, or semiconductor systems, apparatus, or devices, or any suitable combination thereof. More specific examples of a machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

According to one or more embodiments of the present disclosure, there is provided a display control method, which includes:
determining a target control associated with a target trigger rule in response to at least one trigger rule being hit, where the target trigger rule is the hit trigger rule; and
displaying the target control in an input box of a chat interface or an associated area of the input box,
where the target control is configured to perform a corresponding function after being triggered.

According to one or more embodiments of the present disclosure, there is provided a display control method, where in response to at least one trigger rule being hit includes: in response to the at least one trigger rule being hit by received information: or in response to the at least one trigger rule being hit by a detected operation: or in response to the at least one trigger rule being hit by historical information from an associated user of the chat interface.

According to one or more embodiments of the present disclosure, there is provided a display control method, where the target control includes at least one of the following: a time zone information control, an information reply control, a page jump control, an information forwarding control, a target type information display control, or an application control.

According to one or more embodiments of the present disclosure, there is provided a display control method, where the trigger rule includes: at least one of a priority of an associated control, an appearance rule of the associated control, and a hiding rule of the associated control.

According to one or more embodiments of the present disclosure, there is provided a display control method, which further includes:
determining, based on a priority of the target control, a display position of the target control in the input box or the associated area.

According to one or more embodiments of the present disclosure, there is provided a display control method, where if no trigger rule is hit, a suggested control is displayed in the input box of the chat interface or the associated area of the input box, where the suggested control is determined based on a behavior of a current user.

According to one or more embodiments of the present disclosure, there is provided a display control method, where if at least two of target controls are mutually exclusive, a control that needs to be displayed is determined from the mutually exclusive target controls based on the control currently displayed in the input box or the associated area of the input box.

According to one or more embodiments of the present disclosure, there is provided a display control method, where the trigger rule and the control associated with the trigger rule are customizable.

According to one or more embodiments of the present disclosure, there is provided a display control method, where at least one common control is set in the input box of the chat interface or the associated area of the input box, and a registration interface is provided for the common control, where the registration interface is configured to set for the common control at least one of the following: a life cycle, displayed content, a trigger rule, content for determining whether the trigger rule is hit, and a function performed after the trigger rule is hit; and the target control belongs to the common control.

According to one or more embodiments of the present disclosure, there is provided a display control method, where the common control is displayed in a display container of the input box of the chat interface or a display container of the associated area of the input box, and the display container manages a priority of the displayed common control.

According to one or more embodiments of the present disclosure, there is provided a display control method, where user types include a first type of user and a second type of user belonging to the first type of user; and a user with a first permission in the first type of user is able to set whether the second type of user is permitted to customize the trigger rule and the control associated with the trigger rule.

According to one or more embodiments of the present disclosure, there is provided a display control method, which includes: in response to customization of at least one control as a fixed control, fixedly displaying the fixed control in the input box of the chat interface or the associated area of the input box.

According to one or more embodiments of the present disclosure, there is provided a display control method, where n controls are displayable in the input box or the associated area, and if a number of target controls exceeds n, (n-1) target controls and an extended control are displayed in the input box or the associated area, where the extended control is configured to: after being triggered, display a target control that is not displayed in the input box or the associated area.

According to one or more embodiments of the present disclosure, there is provided a display control method, where the target control has displayed content, and the displayed content includes at least one of a text and an icon.

According to one or more embodiments of the present disclosure, there is provided a display control apparatus, which includes:
a control unit configured to determine a target control associated with a target trigger rule in response to at least one trigger rule being hit, wherein the target trigger rule is the hit trigger rule; and
a display unit configured to display the target control in an input box of a chat interface or an associated area of the input box,
where the target control is configured to perform a corresponding function after being triggered.

According to one or more embodiments of the present disclosure, there is provided an electronic device, which includes: at least one memory and at least one processor, where the at least one memory is configured to store program code, and the at least one processor is configured to call the program code stored in the at least one memory to perform the method according to any one of the above embodiments.

According to one or more embodiments of the present disclosure, there is provided a computer-readable storage medium, which is configured to store program code that, when executed by a processor, causes the processor to perform the method described above.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A display control method, comprising:
determining a target control associated with a target trigger rule in response to at least one trigger rule being hit, wherein the target trigger rule is the hit trigger rule; and
displaying the target control in an input box of a chat interface or an associated area of the input box,
wherein the target control is configured to perform a corresponding function after being triggered.

2. The method according to claim 1, wherein in response to at least one trigger rule being hit comprises:
in response to the at least one trigger rule being hit by received information; or
in response to the at least one trigger rule being hit by a detected operation; or
in response to the at least one trigger rule being hit by historical information from an associated user of the chat interface.

3. The method according to claim 1, wherein the target control comprises at least one of the following:
a time zone information control, an information reply control, a page jump control, an information forwarding control, a target type information display control, or an application control.

4. The method according to claim 1, wherein
the trigger rule comprises at least one of a priority of an associated control, an appearance rule of the associated control, and a hiding rule of the associated control.

5. The method according to claim 4, further comprising:
determining, based on a priority of the target control, a display position of the target control in the input box or the associated area.

6. The method according to claim 1, wherein if no trigger rule is hit, a suggested control is displayed in the input box of the chat interface or the associated area of the input box, wherein the suggested control is determined based on a behavior of a current user.

7. The method according to claim 1, wherein
if at least two target controls are mutually exclusive, a control that needs to be displayed is determined from the mutually exclusive target controls based on the control currently displayed in the input box or the associated area of the input box.

8. The method according to claim 1, wherein
the trigger rule and the control associated with the trigger rule are customizable.

9. The method according to claim 8, wherein
at least one common control is set in the input box of the chat interface or the associated area of the input box, and a registration interface is provided for the common control, wherein the registration interface is configured to set for the common control at least one of the following: a life cycle, displayed content, a trigger rule, content for determining whether the trigger rule is hit, and a function performed after the trigger rule is hit; and
the target control belongs to the common control.

10. The method according to claim 9, wherein
the common control is displayed in a display container of the input box of the chat interface or a display container of the associated area of the input box, and the display container manages a priority of the displayed common control.

11. The method according to claim 8, wherein
user types comprise a first type of user and a second type of user belonging to the first type of user; and
a user with a first permission in the first type of user is able to set whether the second type of user is permitted to customize the trigger rule and the control associated with the trigger rule.

12. The method according to claim 1, further comprising: in response to customization of at least one control as a fixed control,
fixedly displaying the fixed control in the input box of the chat interface or the associated area of the input box.

13. The method according to claim 1, wherein
n controls are displayable in the input box or the associated area, and if a number of target controls exceeds n, (n-1) target controls and an extended control are displayed in the input box or the associated area, wherein the extended control is configured to: after being triggered, display a target control that is not displayed in the input box or the associated area.

14. The method according to claim 1, wherein
the target control has displayed content, and the displayed content comprises at least one of a text and an icon.

15. A display control apparatus, comprising:
a control unit configured to determine a target control associated with a target trigger rule in response to at least one trigger rule being hit, wherein the target trigger rule is the hit trigger rule; and
a display unit configured to display the target control in an input box of a chat interface or an associated area of the input box,
wherein the target control is configured to perform a corresponding function after being triggered.

16. An electronic device, comprising:
at least one memory and at least one processor,
wherein the at least one memory is configured to store program code, and the at least one processor is configured to call the program code stored in the at least one memory to perform operations comprising:
determining a target control associated with a target trigger rule in response to at least one trigger rule being hit, wherein the target trigger rule is the hit trigger rule; and
displaying the target control in an input box of a chat interface or an associated area of the input box,
wherein the target control is configured to perform a corresponding function after being triggered.

17. A computer-readable storage medium configured to store program code that, when executed by a processor, causes the processor to perform the method according to claim 1.

18. The electronic device according to claim 16, wherein in response to at least one trigger rule being hit comprises:
in response to the at least one trigger rule being hit by received information; or
in response to the at least one trigger rule being hit by a detected operation; or
in response to the at least one trigger rule being hit by historical information from an associated user of the chat interface.

19. The electronic device according to claim 16, wherein the target control comprises at least one of the following:
a time zone information control, an information reply control, a page jump control, an information forwarding control, a target type information display control, or an application control.

20. The electronic device according to claim 16, wherein
the trigger rule comprises at least one of a priority of an associated control, an appearance rule of the associated control, and a hiding rule of the associated control.
